(19) United States
(12) Patent Application Publication
(10) Pub. No.: US 2013/0069419 A1
(43) Pub. Date: Mar. 21, 2013

(54) HYDRAULIC MOTOR AND CENTRE WHEEL GROUP

(71) Applicant: Piercelestino Pecorari, Modena MO (IT)

(72) Inventor: Piercelestino Pecorari, Modena MO (IT)

(21) Appl. No.: 13/634,849

(22) PCT Filed: Mar. 10, 2011
(86) PCT No.: PCT/IT11/00066

§ 371 Date: Nov. 26, 2012

(30) Foreign Application Priority Data
Mar. 13, 2010 (IT) MO2010A000067

(51) Int. Cl. B60K 7/00

(52) U.S. Cl. CPC B60K 7/0015
USPC 301/6.5

(57) ABSTRACT

A hydraulic motor and centre wheel group, includes a hydraulic motor positioned in line with a centre wheel and connected to the centre wheel in rotation with the motor, and couplings for a mechanical reaction mechanism rotation connected between the hydraulic motor and a support organ or frame for the group. At least one inner race per corresponding crown of rolling bodies of a rolling friction bearing is formed on an outer diameter of a shell of the hydraulic motor. A diametral plane for loading the rolling friction bearing is positioned on a diametral plane characteristic of the hydraulic motor, and the hydraulic motor includes a radial cylinder including a diametral plane which includes the crown of rolling bodies in correspondence with the diametral plane for loading the rolling friction bearing

### FIELD OF APPLICATION

The present invention is a hydraulic motor and centre wheel group, a well-known combination in this technological field in which a hydraulic motor is housed in a centre wheel hub of a vehicle or other instrument or application and together they carry out the generation of rotary motion of the wheel directly in the wheel centre which is powered by hydraulic energy alone.

### PRIOR ART

Existing technology includes various types of motorized centre wheels with the application of a hydraulic motor, both with axial cylinders and with radial cylinders. However, all of them present the joining of the body of the hydraulic motor and the rotating centre wheel with a series of rolling friction bearings arranged in different axial positions to ensure correct support of the centre wheel to the axial and radial thrusts, as well as the bending moments that act on it, due to the specific use for which the centre wheel is intended.

Moreover, in the technical field a coaxial set of speed-reducing gears is often combined with the hydraulic motor and the said centre wheel. Another well-known way of resolving the problem of transmission of motion in centre wheels, in particular in self-propelled vehicles, is to position a slow radial cylinder hydraulic motor, such as the so-called external cam, in order not to need a set of speed-reducing gears. However, these methods do not permit a reduction of the masses in the event that the hydraulic motor and centre wheel complex is required to function more flexibly i.e. that it is required to operate satisfactorily at low, medium and high speeds of rotation. Moreover, a hydraulic motor with external cam radial cylinders has a fixed capacity and this therefore limits the flexibility of the transmission.

Finally, the use of axial or radial cylinder hydraulic motors with a cam or an internal crankshaft tends to lead to worse transmission due to the way in which it is assembled. This assembly requires that the supports and parts that are in contact with the rolling friction bearings, which are used to support the rotating centre wheel, are organized in order to have groups of couplings of a hydraulic motor and centre wheel of a significant mass; furthermore the said groups cannot be used in applications on vehicles where a decreased mass and increased flexibility of optimum use are required at the same time i.e. where a good over-all performance of the mechanical and hydraulic transmission together is required.

The existing technology can be further improved with regards to the possibility of creating a hydraulic motor and centre wheel group that can overcome the above problems. This would make its use simpler and more practical on vehicles or applications where the limits of mass and energetic performance of the existing technology do not allow.

Therefore, the technological problem that forms the basis of this invention is to achieve the assembly of a hydraulic motor inside a wheel centre in order to have a housing for the hydraulic motor which supported in the simplest and most efficient way.

A further and not the last aim of the invention is to achieve a hydraulic motor and centre wheel group in which the hydraulic motor causes as little obstruction within the centre wheel as possible.

Finally, a further part of the technical problem explained above regards achieving a hydraulic motor and centre wheel group in which the hydraulic motor has a large cylinder capacity and the mass of the group is concentrated in correspondence to the rolling friction bearing.

### SUMMARY OF THE INVENTION

This problem is resolved, according to the current invention, by a hydraulic motor and centre wheel group, comprising: a hydraulic motor positioned in line with a centre wheel and connected to it in rotation with the same motor; couplings for a mechanical reaction means to rotation connected between the hydraulic motor and a support organ or frame for the group; it is characterized in that which presents made on the outer diameter of the shell of the hydraulic motor at least one inner race per corresponding crown of rolling bodies of a rolling friction bearing.

In a further form of construction: the centre wheel presents, corresponding to the inner race, at least one outer race, of the said rolling friction bearing, made directly on the inner diameter of the centre wheel.

Moreover, in a specific form, the inner race of the rolling friction bearing is made on the shell of the hydraulic motor in two halves on the diametral plane of the same race.

Furthermore, in a further form, the outer race of the rolling friction bearing is made at the inner diameter of the centre wheel in two halves, on the diametral plane of the same race, and on detachable parts constituting the same centre wheel.

Furthermore, in an optimized form, the rolling friction bearing presents more crowns of rolling bodies, all with at least their corresponding inner races made directly on the shell of the hydraulic motor.

Moreover, in a specific form, the rolling friction bearing presents more crowns of rolling bodies, all with at least the corresponding outer races all made directly on the inner diameter of the centre wheel.

Moreover, in a further and preferred form, the diametral plane for loading the rolling friction bearing is positioned on the diametral plane characteristic of the hydraulic motor being used.

Furthermore, in a preferred and specific form, a hydraulic radial cylinder motor presents the diametral plane containing the crown of cylinders in correspondence with the diametral plane for loading the rolling friction bearing.

Moreover, in a preferred and specific form, the mechanical transmission of the rotational movement between the hydraulic motor and the centre wheel comprises a set of speed-reducing gears.

Finally, in a further form of construction, a hydraulic motor, comprising: a circumferentially developed outer shell connected to couplings for a mechanical reaction means to rotation; it is characterized in that it presents made on the outer shell of the hydraulic motor at least one race per corresponding crown of rolling bodies of a rolling friction bearing.

The characteristics and advantages of the present invention, in the achievement of a hydraulic motor and centre wheel group, will be shown in the description which follows of an example provided as a guide which is not restrictive, with reference to the five drawing tables attached.

### BRIEF DESCRIPTION OF THE DRAWINGS

FIG. 1 represents a schematic axial section of a hydraulic motor and centre wheel group. It has radial cylinders, variable cylinder capacity and an incorporated reducer, according to the invention.

FIG. 2 represents a schematic side view of a hydraulic motor and centre wheel group with incorporated reducer, of FIG. 1, in which in a partial section the centre wheel reaction support is represented for the frame or vehicle on which the group is assembled.

FIG. 3 represents a schematic diametral view III-III, of FIG. 2, i.e. in correspondence with the centre line plane of the cylinders, corresponding to the lying plane of the crown or rolling bodies of the rolling friction bearing in FIG. 1.

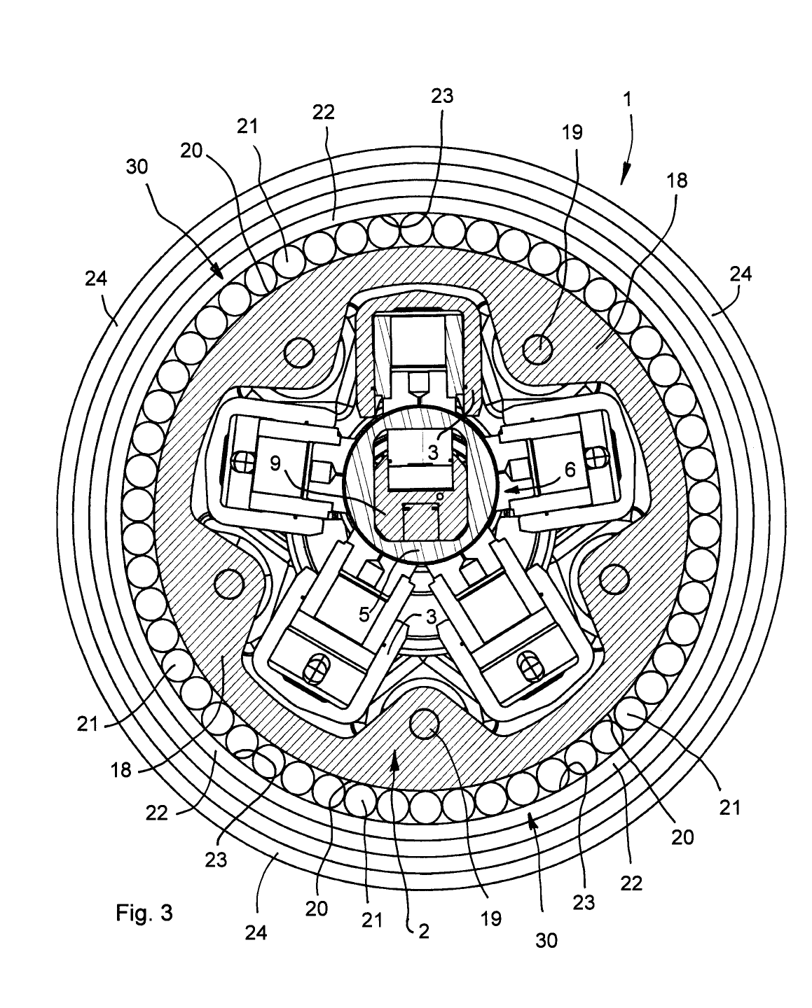

FIG. 4 represents an axial schematic section of a variation embodiment of the inner ring of the rolling friction bearing.

FIG. 5 represents a schematic section of a variation embodiment of the outer ring of the rolling friction bearing.

### DETAILED DESCRIPTION OF A PREFERRED EMBODIMENT OF THE INVENTION

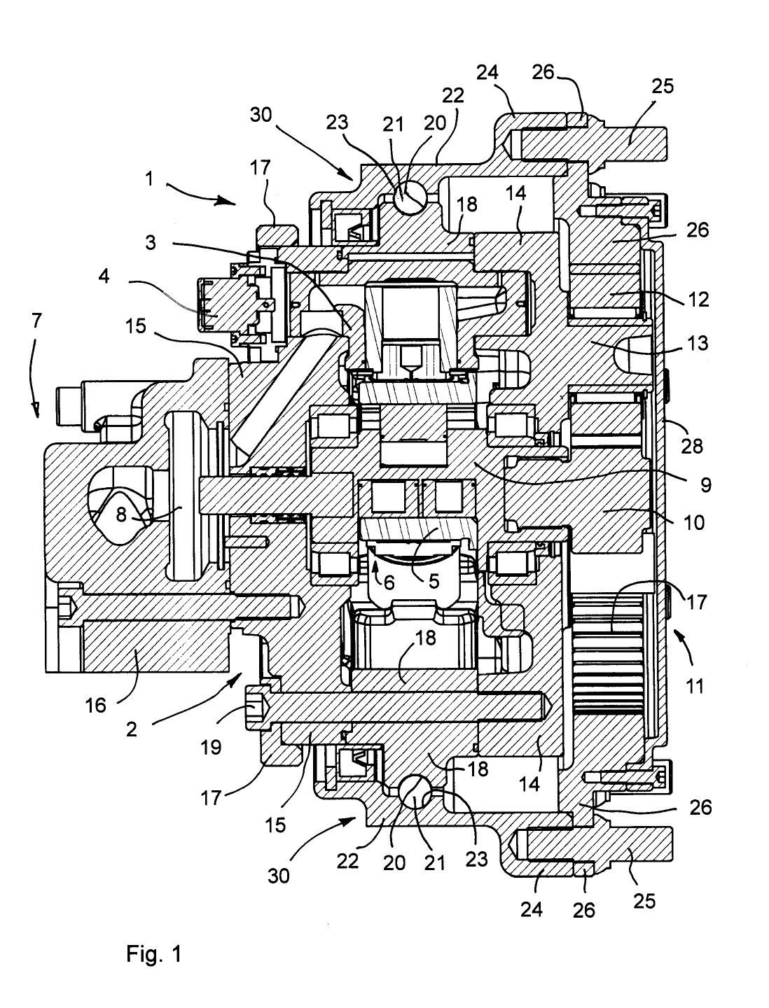

In FIG. 1, a hydraulic motor and centre wheel group 1 can be seen in which the hydraulic motor 2 has oscillating radial cylinders 3, with variable cylinder capacity. The oscillation is controlled by a sensor 4 which detects the amplitude of oscillation to determine the effective cylinder capacity reached, following the arrangement of the ring 5 present in the crank handle 6, according to ways recognized as existing technology. The hydraulic motor presents from the inner side 7 a rotating distributor 8 of hydraulic fluid, under pressure, in the recognized way. This is connected to a crankshaft 9 which is directly coupled on the opposite side with the solar set of gears 10 of a epicyclic reducer 11. The reducer presents satellite sets of gears 12 which are supported in rotation on hubs 13 that are fixed to the shell on the outer side 14 of the hydraulic motor; on the opposite side, the shell on the inner side 15 of the hydraulic motor 2 supports the body of the distributor 16. It is connected by means of a connecting ring 17 to the supporting structure, which is not represented, of the hydraulic motor and centre wheel group 1.

At the joining of the outer shell 14 and the inner shell 15 of the hydraulic motor there is a central ring of the shell 18 which is screwed shut with connecting screws 19 between the outer 14 and inner 15 shells of the hydraulic motor 2.

The central ring of the shell 18 of the hydraulic motor presents at least one inner race 20 at the outer diameter for rolling bodies 21 of a rolling friction bearing, which is represented here by the spheres and the deep throat, or similar bearings which support both the axial thrusts and the radial thrusts and the bending moments. In FIG. 1 the centre wheel 22 can also be seen. On this the outer race 23 for the rolling friction bearing is made. It is equipped with an outer edge 23 on which the threaded hubs 25 are positioned for the assembly of the parts of the wheel, which are not represented. These are intended to support the rotation of the wheel.

Between the threaded hubs 25 and the centre wheel 22 is placed the outer ring 26 with the toothed inner crown 27 of the epicyclic reducer, as is recognized as existing technology. An outer cover 28 closes the lubricated compartment of the reducer 29 which includes the above rolling friction bearing 30.

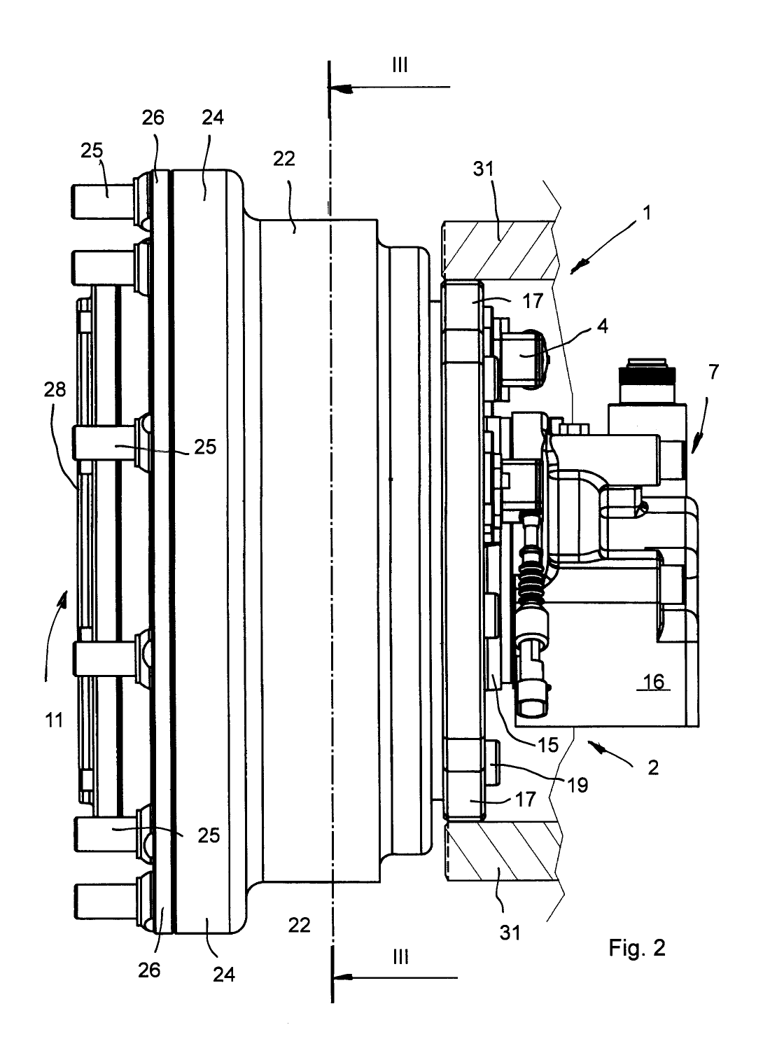

In FIG. 2 a supporting organ 31 for hydraulic motor and centre wheel group 1 can be seen at the frame of the car or vehicle on which the group is assembled.

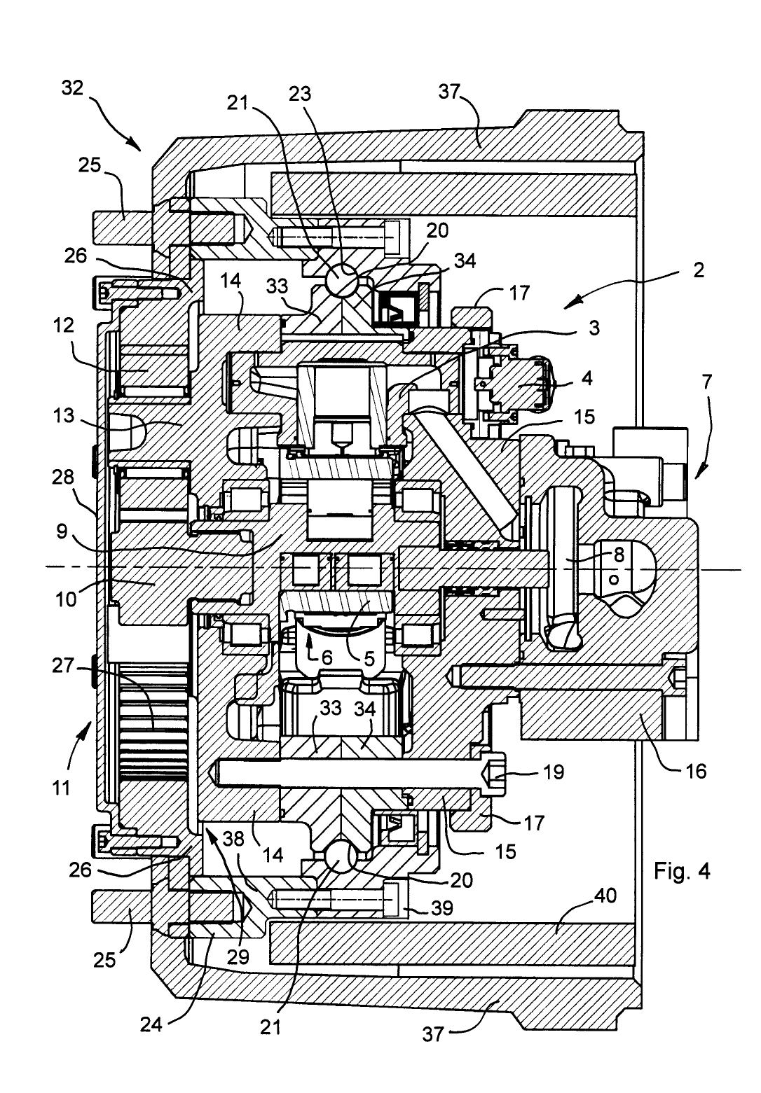

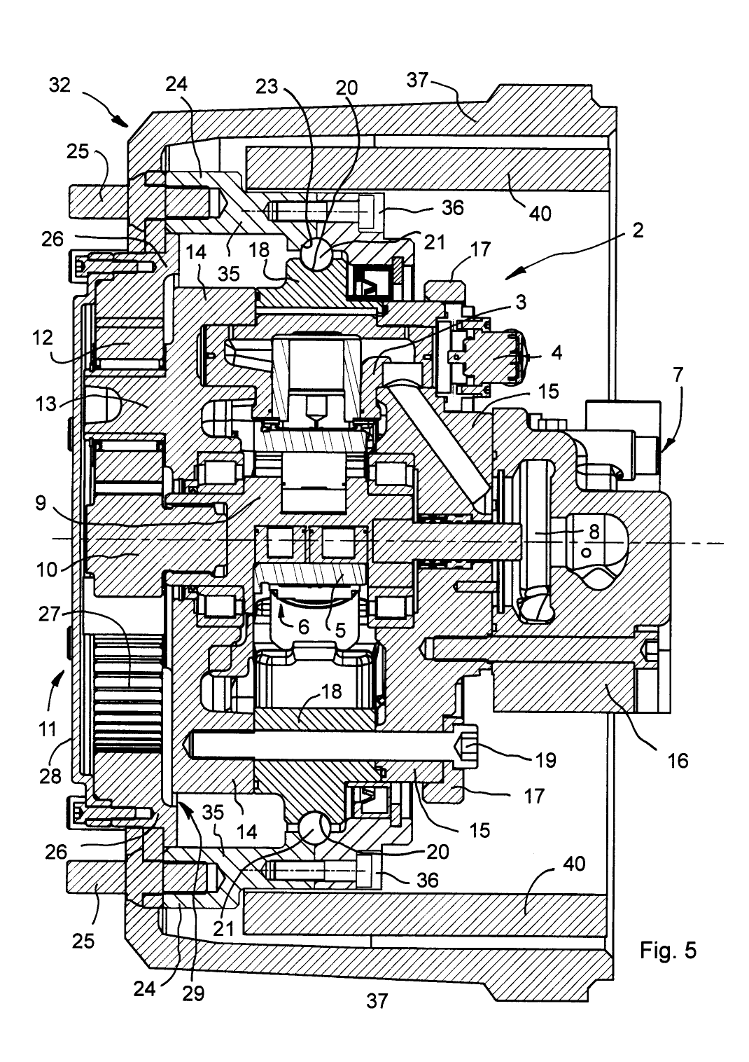

In FIGS. 4 and 5, a hydraulic motor and centre wheel 32 group can be seen in which a variations of the invention are represented. In FIG. 4, this is achieved by constructing an inner ring for the bearing i.e. the central ring of the shell of the hydraulic motor 2 is in two halves 33 and 34. In FIG. 5, an outer ring for the bearing is in two halves 35 and 36 i.e. the rotating part of the centre wheel of the group 1. In this way, a full bearing is created without an axial niche to insert rolling bodies between the inner 20 and outer 23 races.

Furthermore, in the said FIGS. 4 and 5 a bell 37 can be seen which is assembled using the hubs 25 on the centre wheel 35-36 in FIGS. 5 and 38 and 39 in FIG. 4. Finally in the two Figures there is a coaxial cylinder 40 for the brake of a specific application of the hydraulic motor and centre wheel group.

For the races of the inner ring of the rolling bearing the various versions of races for bearings can be used. These are known for their capacity to bear both radial and axial thrusts or even bending moments. However, the representation of a single race i.e. as shown in the Figures with a single crown of spheres is only indicative of the many possible types of rolling friction bearings known for their characteristic of being able to bear the said loads, thrusts and moments.

The hydraulic motor and centre wheel group functions as follows. Both the radial and axial loads are supported and transmitted from the centre wheel, to which they are applied, by means of the rolling friction bearing, directly to the shell of the hydraulic motor inasmuch as the outer race/s is/are a piece i.e. without any couplings or assemblies placed between their diameters. In this way, one avoids the increased thicknesses necessary for securing the contact between an inner diameter of an inner ring of a rolling bearing and the outer diameter of the shell of the hydraulic motor concerned, with an interference, or an assembly with screws or nuts or other things used in the field. This mechanical coupling is known to generate an all over increase of radius of 20 to 40 mm, and is eliminated in the application of the present invention. A hydraulic motor and centre wheel group with a bearing assembled on the shell of the hydraulic motor causes an obstruction greater than 40 to 80 mm on the diameter overall according to the sizing of the hydraulic motor, of any type, and the sizing of the centre wheel.

Furthermore, in the Figures attached, an example of the invention is presented with a specific type of hydraulic motor with a variable displacement, however the radial obstruction is not reduced. This variation has a rolling friction bearing placed in correspondence with the diametral plane of the radial cylinders is able to minimize the inner thrusts on the group between the hydraulic motor and wheel centre and obtain the minimum possible obstruction for the use of a hydraulic motor with the same characteristics in a centre wheel. The reduction of obstruction is not only evident in the reduction of material used for coupling between the rolling friction bearing and the shell of the hydraulic motor, but also in the reduction of the axial obstruction of the group which reduces the masses of the parts used and their axial position. This allows for the minimizing of the space occupied by the group, according to the invention during assembly on a vehicle or frame.

The advantages of adopting the hydraulic motor and centre wheel group described can be summarized as follows. The hydraulic motor and centre wheel group allows for the reduction of the obstruction and the masses concerned during coupling between a centre wheel and a hydraulic motor assembled inside it. Furthermore, having the race or races of the rolling friction bearing directly on the shell of the hydraulic motor allows for the simplification and minimization of the transmission of forces, radial or axial pushers and the moments within the group itself. Finally the form represented i.e. the radial cylinder hydraulic motor placed in the diametral plane of the rolling bearing creates the minimum interior stress between the hydraulic motor, which is radial and therefore has all of the thrusts generated on the diametral plane of the star of cylinders, and the centre wheel. Therefore the invention overcomes the limits of the existing technology which presents axial developments of the groups which are also very relevant. In conclusion, the possibility of having the number or races necessary on the shell of the hydraulic motor allows for a versatility of the present invention on all types of hydraulic motor and centre wheel group known in the field and provides the decided advantages cited above.

It is clear that a technician in the field, whose objective is to satisfy specific demands in certain situations, will be able to make numerous adjustments to a hydraulic motor and centre wheel group. All of these adjustments, however, will come into the area that protects the present invention which is defined in the following claims. Therefore, although it would be less beneficial, only the inner race of the rolling friction bearing can be made on the shell of the hydraulic motor, as said above, and the outer race can be transferred or made in pieces on an inner diameter of the centre wheel.

1. A hydraulic motor and centre wheel group, comprising:
a hydraulic motor positioned in line with a centre wheel and connected to the centre wheel in rotation with the motor; and
couplings for a mechanical reaction mechanism rotation connected between the hydraulic motor and a support organ or frame for the group,
wherein at least one inner race per corresponding crown of rolling bodies of a rolling friction bearing is formed on an outer diameter of a shell of the hydraulic motor,
wherein a diametral plane for loading the rolling friction bearing is positioned on a diametral plane characteristic of the hydraulic motor, and
wherein the hydraulic motor comprises a radial cylinder including a diametral plane which includes the crown of rolling bodies in correspondence with the diametral plane for loading the rolling friction bearing.

2. A hydraulic motor and centre wheel group according to claim 1, wherein the centre wheel comprises, corresponding to the inner race, at least one outer race, of the said rolling friction bearing, formed directly on an inner diameter of the centre wheel.

3. A hydraulic motor and centre wheel group according to claim 1, wherein the inner race of the rolling friction bearing is formed on the shell of the hydraulic motor in two halves on the diametral plane of the same race.

4. A hydraulic motor and centre wheel group according to claim 2, wherein the outer race of the rolling friction bearing is formed at the inner diameter of the centre wheel in two halves on the diametral plane of the same race, and on detachable parts constituting the same centre wheel.

5. A hydraulic motor and centre wheel group according to claim 1, wherein the rolling friction bearing comprises a plurality of crowns of rolling bodies, all with at least their corresponding inner races made directly on the shell of the hydraulic motor.

6. A hydraulic motor and centre wheel group according to claim 5, wherein in the rolling friction bearing the corresponding outer races are all made directly on an inner diameter of the centre wheel.

7. (canceled)

8. (canceled)

9. A hydraulic motor and centre wheel group, according to claim 2, wherein a mechanical transmission of a rotational movement between the hydraulic motor and the centre wheel comprises a reduction gear.

10. (canceled)
